(19) United States
(12) Patent Application Publication
(10) Pub. No.: US 2007/0239289 A1
(43) Pub. Date: Oct. 11, 2007

(54) System and software for processing containers having tools with associated transmitters

(75) Inventors: Christopher Cambre, Collierville, TN (US); Marnita Holmes, Lakeland, TN (US); Robert Varner, Germantown, TN (US); Steven M. Tethrake, Collierville, TN (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: SDGI Holdings, Inc.

(21) Appl. No.: 11/279,330

(22) Filed: Apr. 11, 2006

(51) Int. Cl. G05B 19/18

(52) U.S. Cl. 700/64

(57) ABSTRACT

A software method may include receiving scan data from a device after the device retrieves a readable code from a container, the container having at least one transmitter contained therein, processing the scan data to generate a container code based on the readable code, receiving a signal from the at least one transmitter, the signal including identification information, generating a transaction code based on the container code and the identification information, and instructing the device to transmit the transaction code to a processing device.

### FIELD OF THE INVENTION

The embodiments generally relate to a system and software for management of tools, and more specifically to a system and software for tracking tools in supply chain management.

### BACKGROUND OF THE INVENTION

Surgical instrument storage and sterilization systems are known. These systems, sometimes referred to as surgical instrument trays or surgical instrument kits, typically include metal or plastic trays that hold a variety of general purpose and/or procedure specific surgical instruments, such as, forceps, scissors, clamps, retractors, scalpels, etc. These trays are brought into the operating room (OR) when preparing for surgery, and also are used as a means to organize, transport, and store surgical instruments in a medical facility.

A primary function provided by surgical trays, in addition to storage, is to facilitate group sterilization. Sterilization is of paramount importance in a surgical setting, such as a hospital, to prevent patients undergoing surgery from contracting potentially deadly infections. Prior to and after every surgical procedure, all surgical instruments and trays must be sterilized before subsequent usage. In order to increase the speed and efficiency of sterilization, entire surgical trays containing several instruments often are placed in a sterilization chamber all at once. The sterilization chamber may expose the trays and all instruments contained therein to any combination of heat, pressure, fluid, and/or vaporous sterilant. Sterilization techniques are well known. Thus, a detailed discussion of sterilization techniques has been intentionally omitted.

Over time, and through ordinary usage as well as due to rigors of the sterilization process, surgical instruments suffer wear and tear and eventually reach the end of their life cycle. Thus, it is necessary to periodically inspect and maintain records on usage of surgical instruments so that they can be replaced as necessary. Also, since the instruments are constantly moved from the operating room to sterilization, to storage through processing facilities, and back to the operating room, various instruments on a given tray may become lost or placed in the wrong tray. Because certain instruments are so specialized that there are no functional substitutes, it also has become necessary to regularly inspect trays, and to identify any missing instruments.

The need to perform sterilization and the general need to maintain surgical instrument kits in good working order usually requires surgical instrument kits to be transported in and out of medical facilities through a distribution center for processing. For example, several surgical instrument kits may be picked up at one time from a hospital or other medical facility. In order to easily and efficiently transport the kits, several kits are placed in a single shipping tote. The shipping, tote is a large bin, usually made of plastic or other durable, lightweight material that is able to securely hold two or more instrument kits. A worker then may load the shipping totes into a vehicle, thereby reducing the number of manual operations that must be performed. Before transporting each shipping tote, a bar coded shipping label is sometimes prepared that identifies certain information about the tote. These labels are sometimes referred to as “airbills.”

Airbills sometimes cause problems, however, when processing totes. Airbills do not indicate which surgical instruments are included in the tote. Oftentimes, surgical instruments are placed on incorrect trays in the tote and are shipped to the incorrect manufacturer for inspection and sterilization. Moreover, once a surgical tool has been placed on an incorrect tray, no efficient system exists to determine this error until the tote is opened for processing. This causes time delays in processing the surgical instruments to redirect the surgical instrument to the correct destination, and may be particularly detrimental for high value surgical instruments.

Problems in processing totes also occur since identifying surgical instruments is often problematic and labor intensive. Existing technology for uniquely marking surgical instruments for identification is based upon visual markings, bar coding, or two-dimensional (2D) matrix (micro-dots) marking. Existing methods for performing necessary identification functions of the surgical instruments are reliant on costly human interpretation. In some cases, a skilled technician may be required to identify the surgical instruments, which keeps the skilled technician from performing other valuable functions. Additionally, existing technologies have limitations of being orientation restrictive, highly manual, require complex manufacturing processes, or are intrusive to the user of the instrument.

It is noted that the description herein of various advantages and disadvantages associated with known apparatus, methods, and materials is not intended to limit the scope of the embodiments to their exclusion. Indeed, various exemplary embodiments described herein may include one or more of the known apparatus, methods, and materials without suffering from their disadvantages.

### SUMMARY OF THE INVENTION

There is a need for a system and software for improved processing and managing of tools.

Exemplary embodiments may include a system and a method for managing and processing information regarding surgical instruments and tools.

A method according to exemplary embodiments may include receiving scan data from a device after the device retrieves a readable code from a container, the container having at least one transmitter contained therein, processing the scan data to generate a container code based on the readable code, receiving a signal from the at least one transmitter, the signal including identification information, generating a transaction code based on the container code and the identification information, and instructing the device to transmit the transaction code to a processing device.

A software method for a processing device according to exemplary embodiments may include receiving a transaction code transmitted from a device, the transaction code including data corresponding to a container code of a container and identification information of a transmitter associated with the container, updating a database table based on the container code and the identification information, generating a response code based on information stored in the database table, the response code being usable by the device to generate a response indicator for processing the container, and transmitting the response code to the device.

A system for monitoring a tool having an integrated transmitter may include an access point, a container, the container comprising a readable code and having at least one transmitter contained therein, a device including a wireless communication device and a scanning device, the device being adapted to retrieve the readable code with the scanning device and, at the wireless communication device, being adapted to generate a wireless signal and to receive a response signal transmitted from the transmitter in response to the wireless signal, the device being adapted to generate a transaction code based on the readable code and the response signal, and to transmit the transaction code to the access point.

These and other features and advantages of the present invention will be apparent from the description of exemplary embodiments provide herein.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 illustrates an exemplary embodiment of a system;

FIG. 2 illustrates an exemplary embodiment of a GUI displayable in a display of a Device;

FIGS. 3A-B illustrate a flow diagram of an exemplary embodiment of software operations performed at the Device;

FIG. 4 illustrates a flow diagram of an exemplary embodiment of software operations performed at a Database;

FIG. 5 illustrates an exemplary embodiment of a GUI display presented to an operator of the Device corresponding to FIGS. 3-4;

FIG. 6 illustrates an exemplary embodiment of a GUI display presented to an operator of the Device corresponding to FIGS. 3-4;

FIG. 7 illustrates an exemplary embodiment of a GUI display presented to an operator of the Device corresponding to FIGS. 3-4;

FIG. 8 illustrates an exemplary embodiment of a tray holding various tools; and

FIG. 9 illustrates an exemplary tool having an associated transmitter.

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

The following description is intended to convey a thorough understanding of the embodiments by providing a number of specific exemplary embodiments and details involving exemplary systems and software for processing a container and tools having associated transmitters stored within the container. It should be appreciated, however, that the embodiments are not limited to these specific embodiments and details, which are exemplary only. It is further understood that one possessing ordinary skill in the art, in light of known systems, methods, and apparatuses, would appreciate the use of the embodiments for their intended purposes and benefits in any number of alternative embodiments, depending upon specific design and other needs.

The terminology used herein is for the purpose of describing particular embodiments only and is not intended to limit the scope of the present invention. As used throughout this disclosure, the singular forms “a,” “an,” and “the” include plural reference unless the context clearly dictates otherwise. Thus, for example, a reference to “a tool” includes a plurality of such tools, as well as a single tool, and a reference to “an instrument” is a reference to one or more instruments and equivalents thereof known to those skilled in the art, and so forth.

Unless defined otherwise, all technical and scientific terms used herein have the same meanings as commonly understood by one of ordinary skill in the art to which this invention belongs. All publications mentioned herein are cited for the purpose of describing and disclosing the various implants, prosthesis, components, methods of implantation, coatings and surface treatments, and other components that are reported in the publications that might be used in connection with the embodiments. Nothing herein is to be construed as an admission that the embodiments described herein are not entitled to antedate such disclosures by virtue of prior invention.

As used herein, the expressions and terms “surgical instrument,” “surgical tool,” “instrument,” or “tool” will refer to any type of surgical or medical instrument or portable equipment or device to which it may be desirable to attach a transmitter, such as, but not limited to, a radio frequency identification (RFID) tag. Though the specification is written in the context of medical and/or surgical instruments, it should be appreciated that the RFID tag of the various exemplary embodiments may be used with a variety of different items to be identified as shape and design constraints permit, including tools and equipment in other fields unrelated to the medical field. This may include hand tools or other objects and/or equipment that are used in construction, manufacturing, maintenance or other industries. All of these uses are within the intended scope of the embodiments.

Exemplary embodiments may generally relate to a system and software applications for processing and generating data for tracking tools and containers. In various exemplary embodiments, a processing center may receive one or more containers from, for example, a company, a hospital, or other organization. At the processing center, an operator, without opening the container, may determine information on the numbers and types of tools included within each container. Based on the obtained information, the operator may forward the container to an appropriate destination for processing of the tools, which may include, but is not limited to, inspection, sterilization, usage, or storage.

Software according to various exemplary embodiments may make possible wireless in-bound processing of containers at any location of the processing center. Implementing software and a system as described herein may allow for the processing of the container to be done on or near a receiving dock, on a truck delivering the containers, or at some other physical location where the containers are received.

Exemplary embodiments describe computer software that operates a device, such as a handheld device, for tracking and facilitating processing of the container and the tools. The exemplary software may manage data connectivity of the device with a database and may manage an easy to navigate user interface for instructing an operator to efficiently process containers and tools.

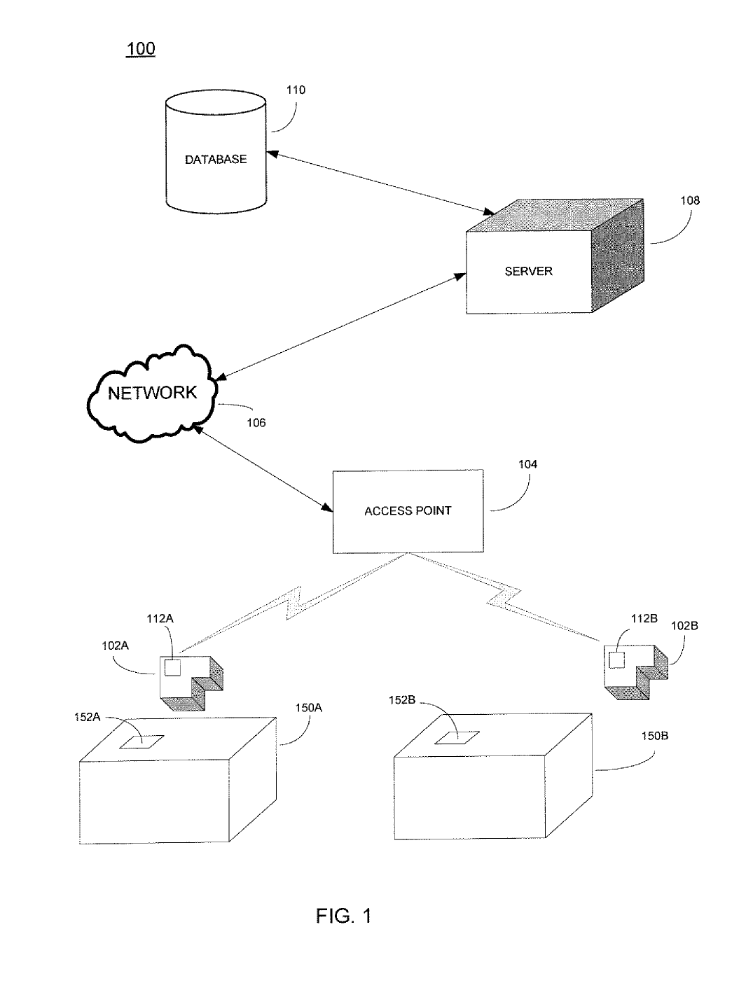

FIG. 1 illustrates an exemplary embodiment of a system 100. In the depicted embodiment, the system 100 may include Devices 102A-B, an Access Point 104, a Network 106, a Server 108, and a Database 110. The Devices 102A-B and the Access Point 104 may be located at a processing center, such as, but not limited to, a warehouse, a distribution center, or a building. A truck or other transport vehicle may arrive at the processing center and may drop off one or more containers 150. The container 150 may be composed of, for example, plastic, metal, or other durable, lightweight material, as will be appreciated by those of skill in the art. The container 150 may also be referred to as a tote. In FIG. 1, two Devices 102A-B and two containers 150A-B are depicted, however, the system 100 may use more or less Devices 102 or containers 150, as will be appreciated by those skilled in the art.

The system 100 may obtain information about each container 150 to aid an operator in efficiently processing the container 150. As the containers 150 arrive, one or more operators may begin processing the containers 150 with the Device 102. The Device 102 may obtain information that uniquely identifies the container 150, and may obtain information that uniquely identifies the contents of the container 150.

A readable code 152 may be attached to the container 150. In various exemplary embodiments, the readable code 152 may be optically readable, such as, but not limited to, a bar code. In various alternative exemplary embodiments, the readable code 152 be wirelessly readable with, for example, but not limited to, a radio frequency (RF) reader. The readable code 152 may store a container code that uniquely identifies the container 150 from other containers. The readable code 152 also may identify certain information, such as, but not limited to, the point of origin, the destination, and possibly the contents of the container 150, i.e., identification information for each tray or tool stored within the container 150. The readable code 152 also may be known as air bill data.

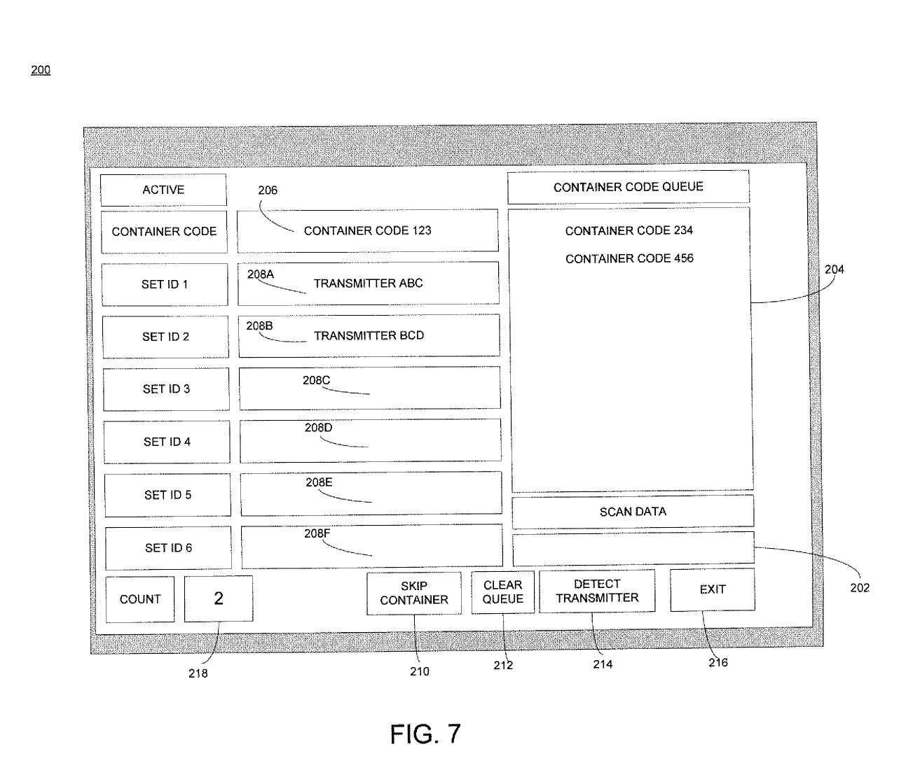

In an exemplary embodiment, the container 150 may have multiple tools 854A-E placed and closed within the container 150 (also see FIG. 8). The container 150 may be closed with a lid or other suitable closure so that the tools 854 may be enclosed within an interior of the container 150. The container 150 may store, for example, but not limited to, surgical trays, trays, trunks, and carriers, that may be used to store one or more tools 854. Within the container 150, the tools 854 may be arranged on one or more trays, within a sterile carrier case, within a trunk, or may be loose. The tools 854 also may not generally be externally visible when enclosed within the container 150. The container 150 may store, for example, hazardous substances, such as, but not limited, surgical instruments after being used in surgery. Generally, the operators may use the Device 102 to process the containers 150 without opening the containers 150.

FIG. 8 illustrates an exemplary embodiment of a tray holding various tools. As depicted, arranged on a tray 802 are various tools, such as surgical instruments, including, but not limited to, scissors 854A, a scalpel 854B, tweezers 854C, scissors 854D, and a saw 854E. The tray 802 may be placed in the container 150. It is noted that more or less tools 854 may be included on the tray 802. Alternatively, the tools 854 may be other types of tools, such as, but not limited to, automotive, consumer, aviation, etc., as will be appreciated by those of skill in the art.

The container 150 may transport the tray 802 containing the tools 854 for processing. Processing of the tools 854 may include, but is not limited to, sterilization, inspection, storage, usage, or transport between facilities, hospitals, or processing centers. Processing may occur at the processing center, or the processing center may forward the containers 150 to their respective destinations for processing.

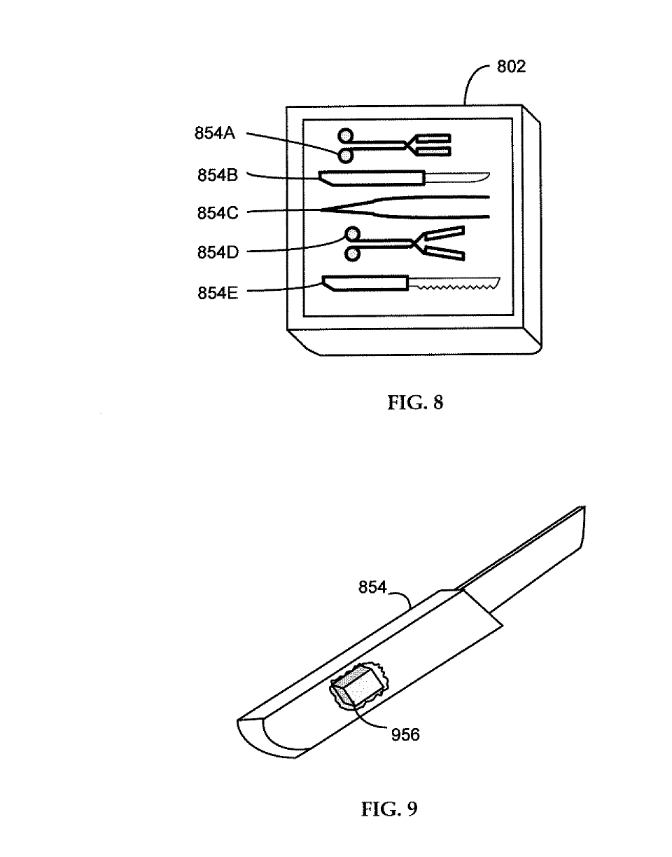

A transmitter 956 may be associated with each tool 854 for communicating with the Device 102. FIG. 9 illustrates an exemplary tool 854 having an associated transmitter 956. As depicted, the transmitter 956 may be embedded within the tool 854. Alternatively, the transmitter 956 may be embedded in the tray 802. The transmitter 956 may be a miniature electronic circuit that may include a microprocessor. The transmitter 956 may be adapted to wirelessly communicate with the Device 102. The transmitter 956 may be passive, where the transmitter 956 only transmits a signal after receiving a signal from another source. Alternatively, the transmitter 956 may be active and periodically or aperiodically transmit signals. The transmitter 956 may be wireless signal powered (also known as beam powered), where power from a received signal energizes the transmitter 956 and may cause the transmitter to perform a data operation, such as, but not limited to, emitting a wireless signal. In various exemplary embodiments, the transmitter 956 may communicate wireless signals, such as, but not limited to, radio frequency (RF) signals, Ultra-High Frequency (UHF) signals, Microwave Frequency signals, or other wireless signals capable of containing information. In an exemplary embodiment, the transmitter 956 may include an RFID tag. The basic structure and operation of RFID tags can be found in, for example, U.S. Pat. Nos. 4,075,632, 4,360,801, 4,390,880, 4,739,328 and 5,030,807, the disclosures of which are incorporated herein by reference in their entireties.

The system 100 may allow the transmitter 956 to wirelessly communicate information about the tool 854 and/or the tray 802 from the Device 102 to the Database 110, without requiring an operator to open and manually inspect the one or more tools 854 stored within the container 150 (see FIG. 1). The system 100 may use the information to track and manage the tool 854 at the Database 110. The transmitter 956 may wirelessly transmit the information to the Access Point 104 for transmission to the Network 106, to the Server 108, and, ultimately, to the Database 110. In an alternative embodiment, the Access Point 104 may be tethered to the Device 102 via a wire. The Access Point 104 may directly connect to the Network 106, or may connect through a local area network (LAN), a wireless LAN (WLAN), an Internet Service Provider (ISP), or other methods for connecting to a network, which are known and are omitted for brevity. The Network 106 may be a data network, a communications network, a computer network, an Internet, an Intranet, or other types of networks useable to transmit information between processing devices. The Server 108 may monitor and control connectivity and data transmission for the System 100 through the Network 106. The Server 108, the Database 110, or both may be located within a single building with the Access Point 104, or alternatively one or more may be located in different buildings or remote to one another.

The Device 102 may extract information from the container 150 and one or more tools 854 with minimal manual manipulation of the container 150 by an operator. In an exemplary embodiment, the Device 102 may include an optical scanning device and a wireless reader device. The optical scanning device may be a wand reader (i.e., light source and a photo diode), a laser scanner, a Charged Coupled Device (CCD) reader, a camera based reader, or other types of optical scanning devices, as will be appreciated by those of skill in the art. The wireless reader device may be, but is not limited to being, a radio frequency (RF) field generator. The Device 102 may use the optical scanning device to optically read the optically readable code 152 placed on the container 150, and may use the wireless reader device to wirelessly extract identification information from data stored in a memory of the transmitter 956. The identification information may include, such as, but not limited to, a Universal Product Code (UPC), a product name, a unique identification number, a processing order (i.e., process the container in the order received, process ahead of other containers and quickly forward to destination, etc.), the name of the manufacturer, a number of uses, a number of sterilizations, a last sterilization date, a last usage date, a point of origin, a destination, a number of refurbishments, an age, a name of one or more previous users, usage dates, or other information that may be useful in managing the tool and/or tray over its life cycle, etc.

In an alternative embodiment, the Device 102 may include a wireless reader device, and may not include the optical scanning device. A transmitter 956 may be embedded in or attached to the container 150. A memory of the transmitter 956 associated with the container 150 may store information similar to that contained in the readable code 152 and also may store identification information. In this alternative embodiment, the processing performed in evaluating data communicated from the transmitter 956 associated with the container 150 to the wireless reader device may be similar to the processing performed in evaluating data received from scanning the readable code 150 with the optical reader device.

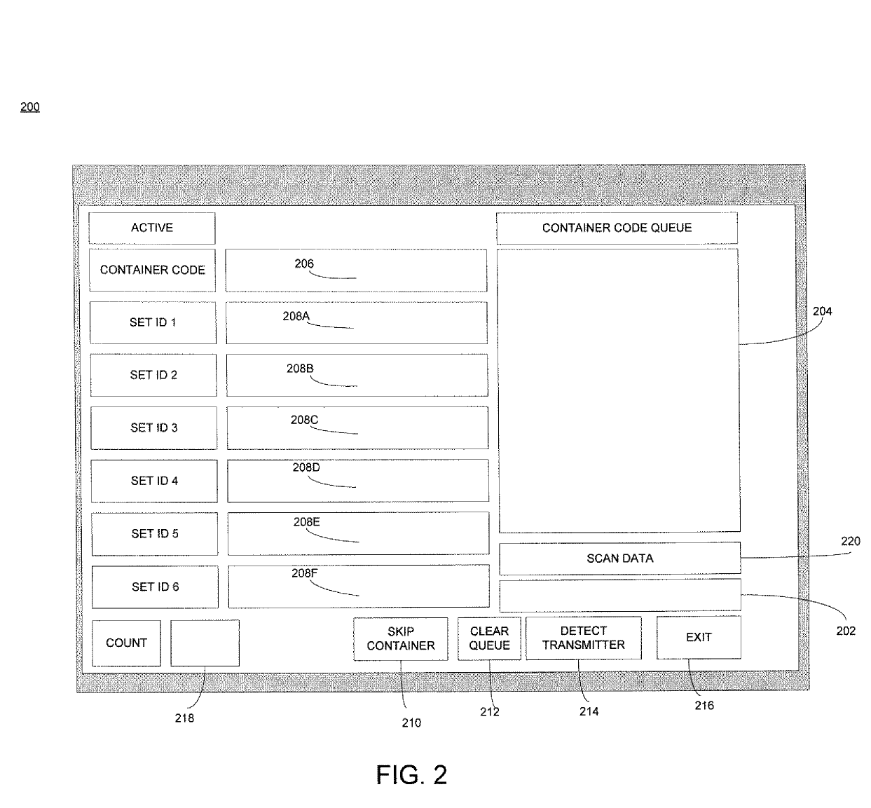

In various exemplary embodiments, the Device 102 may include a display adapted to display a graphical user interface (GUI) for aiding the operator in processing the container 150. FIG. 2 illustrates an exemplary embodiment of a GUI 200 displayable in Display 112 of the Device 102. The operator may launch the GUI 200 by selecting an icon or a menu item from a system interface of the operating system. Computer software running on the Device 102 may be useable with Windows®, Pocket PC®, Apple OS®, or other operating system menu schemes. The GUI 200 may provide the operator an easily navigateable interface into the underlying computer software that controls the Device 102 and may allow for easy diagnostics and interrogation of functions of the Device 102 without entering into the underlying firmware and application software.

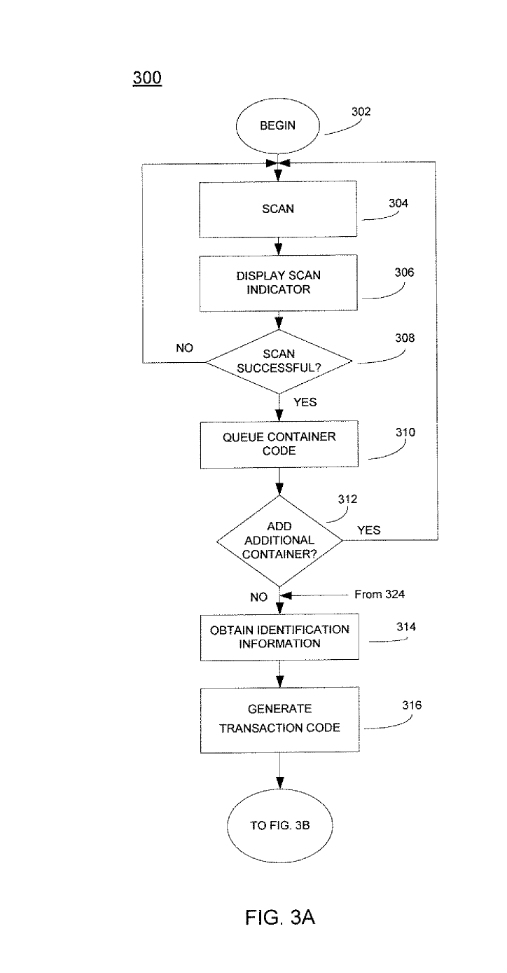

According to various exemplary embodiments, the GUI 200 may include numerous fields for interacting with the operator. For example, the GUI 200 may include a Scan Data Field 202, a Container Code Queue Field 204, an Active Container Code Field 206, Active Set Identification Fields 208A-F, a Skip Container Field 210, a Clear Container Code Queue Field 212, a Detect Transmitter Field 214, an Exit Field 216, and a Count Field 218. The following briefly describes the above fields. The remaining description of these fields is provided with reference to FIGS. 3-7, as provided below.

The Scan Data Field 202 may display data scanned by the optical scanning device of the Device 102. The Container Code Queue Field 204 may display one or more container codes read by the Device 102 and queued by software of the Device 102. The Active Container Code Field 206 may display the container code presently being processed by software of the Device 102. The Active Set Identification Fields 208A-F individually may display identification information received from the transmitter 956 of the tool 854. The Skip Container Field 210 may receive a user selection to skip over a container code currently queued in the Container Code Queue Field 204 and proceed to the following container code.

The Clear Container Code Queue Field 212 may receive a user selection to remove one or more of the container codes stored in the queue displayed in the Container Code Queue Field 204. The Detect Transmitter Field 214 may receive a user selection to instruct the Device 102 to communicate with transmitters 956 to obtain their identification information. The Exit Field 216 may receive a user selection to close the GUI 200. The Count Field 218 may display the number of transmitters 956 from which the Device 102 has received identification information. The GUI 200 also may include a Shipment Identification (ID) Field to display shipping information to where the container 150 may be shipped or other Message Fields. The GUI 200 may include other combinations of these fields, or various fields may be added, omitted, or rearranged, or some combination thereof, as will be appreciated by those of skill in the art.

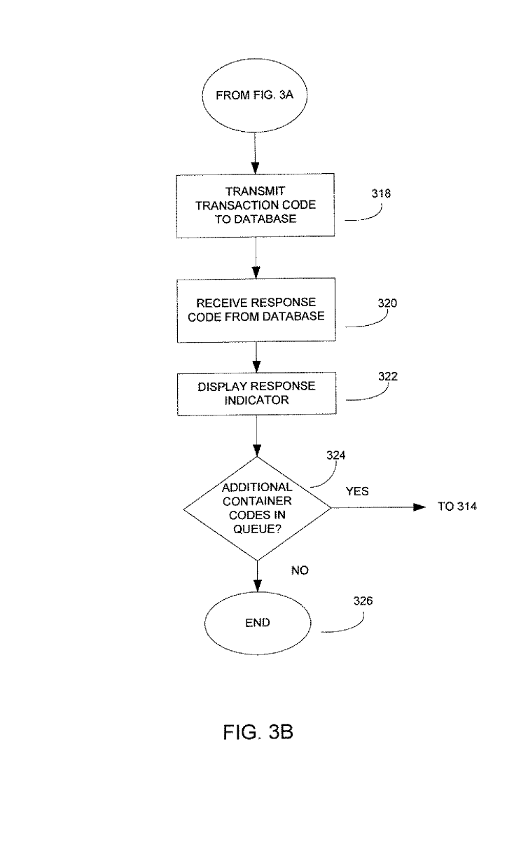

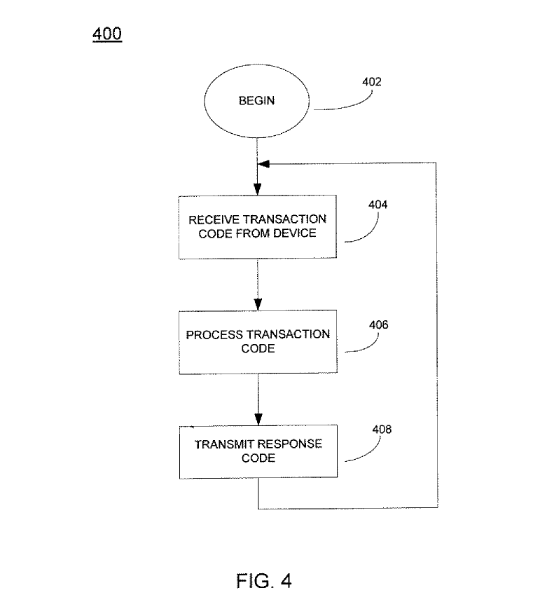

The following describes exemplary embodiments of computer software executable on the Device 102, the interaction of the operator with the GUI 200 and the Device 102, and the interaction of the Device 102 and the Database 110 in the System 100. FIGS. 3A-B illustrate a flow diagram 300 of an exemplary embodiment of software operations performed at the Device 102, FIG. 4, illustrates a flow diagram 400 of an exemplary embodiment of software operations performed at the Database 110, and FIGS. 5-7 illustrate exemplary embodiments of GUI displays presented to an operator of Device 102 corresponding to FIGS. 3-4. The following exemplary embodiments are discussed with reference to FIGS. 1-7.

In FIG. 3, the flow diagram 300 may begin at 302 and may continue to 304. In 304, the software of the Device 102 (the device software) monitors the Device 102 to determine when the operator, using the Device 102, captures scan data from the one or more containers 150 received at a processing center. Scan data may be the information detected at the optical scanning device of the Device 102 from the container 150 when the operator operates the Device 102 to read the readable code 152. Alternatively, scan data may be information detected by the wireless reader device of Device 102 from the readable code 152 of the container 150. To activate the optical scanning device, the operator may actuate an actuation device, such as, but not limited to, a button or trigger, on the Device 102 to instruct the optical scanning device to scan the readable code 152, or alternatively, the operator may select a field on the GUI 200 to activate the optical scanning device, such as the Scan Data Field 220. After the operator attempts to scan the readable code 152 with the Device 102, the device software may process the scan data to determine if the Device 102 successfully obtained the readable code 152. The flow diagram 300 may then continue with 306.

In 306, the device software instructs the GUI 200 to display a scan indicator after processing the scan data. The scan indicator may inform the operator if the optical scanning device of the Device 102 successful scanned the readable code 152. The scan indicator may be a visual cue displayable at the Display 112. Alternatively, the scan indicator may be an auditory cue or the Device 102 may vibrate. The flow diagram may then continue with 308.

In 308, if the scan is unsuccessful, the device software may repeat 304 and 306 until the optical scanning device successfully obtains the readable code 152, or after a number of attempts, the device software may display an error condition if the optical scanning device is unable to obtain the readable code 152.

If the scan is successful, the device software may determine a container code from the obtained scan data. In various exemplary embodiments, the container code may be data included in the readable code 152 and may be used to uniquely identify the container 150. The device software may format the container code to a desired format from several different types of formats that the readable code 152 may use. Various formats may include UPC-A, UPC-E, EAN-13, EAN-8, CODE 39, CODE 128 (A, B, C), CODE 2 OF 5 INTERLEAVED, CODABAR, Bookland (ISBN), MSI PLESSEY, Postnet, or other known bar code formats. Formatting the container code may ensure that the identification information obtained from the transmitters 956 is associated with the correct container code. The flow diagram 300 may then continue with 310.

In 310, the device software may place the container code in a queue. The device software may process the queue of container codes as a first in first out (FIFO) queue, a last in first out (LIFO) queue, or other queue management techniques, as will be appreciated by those of skill in the art. The GUI 200 also may display the queued container code. FIG. 5 illustrates an exemplary embodiment of displaying a container code in the Container Code Queue Field 204. Once the device software queues the container code, the software updates the Container Code Queue Field 204 to include the queued container code. As depicted, container codes 510A-C may be listed in the Container Code Queue Field 204. The process of adding a container code to the Container Code Queue Field 204 also may be referred to as populating the Container Code Queue Field 204. Each container code in the Container Code Queue Field 204 may represent a container 150 where the Device 102 has not yet obtained identification information from the transmitters 956 within the container 150. In processing the containers 150, the operator may queue a single container code or may queue a predetermined number of container codes before obtaining the identification information from the transmitters 956, as will be discussed below. The flow diagram 300 may then continue with 312.

In 312, the device software may display a question inquiring whether the operator would like to add additional container codes before obtaining the identification information from the transmitters 956 within the container 150. If no, the flow diagram 300 may continue with 314. If yes, the flow diagram 300 may return to 304 to add additional container codes from other containers. Once the operator adds a desired number of container codes, the flow diagram may continue with 314.

In 314, the device software may await instructions from the operator to begin obtaining identification information from the one or more tools 854 and/or trays 802 within the container 150. In an exemplary embodiment, to obtain data from the transmitters 956 associated with the tools 854 and/or trays 802, the operator may select the Detect Transmitter Field 214 (see FIG. 5) on the GUI 200 that will allow the Device 102 to switch from optical scanning using the optical scanning device to wireless reading using the wireless reader device such as, but not limited to, a RFID reader. In an alternative embodiment, the Device 102 may automatically switch from the optical scanning device to the wireless reader device after obtaining the readable code 152 or it may already be in the wireless reader mode by virtue of having initially scanned containers 150 using this technique. In a further alternative exemplary embodiment, the GUI 200 may have separate interfaces for the optical scanning device and for the wireless reader device.

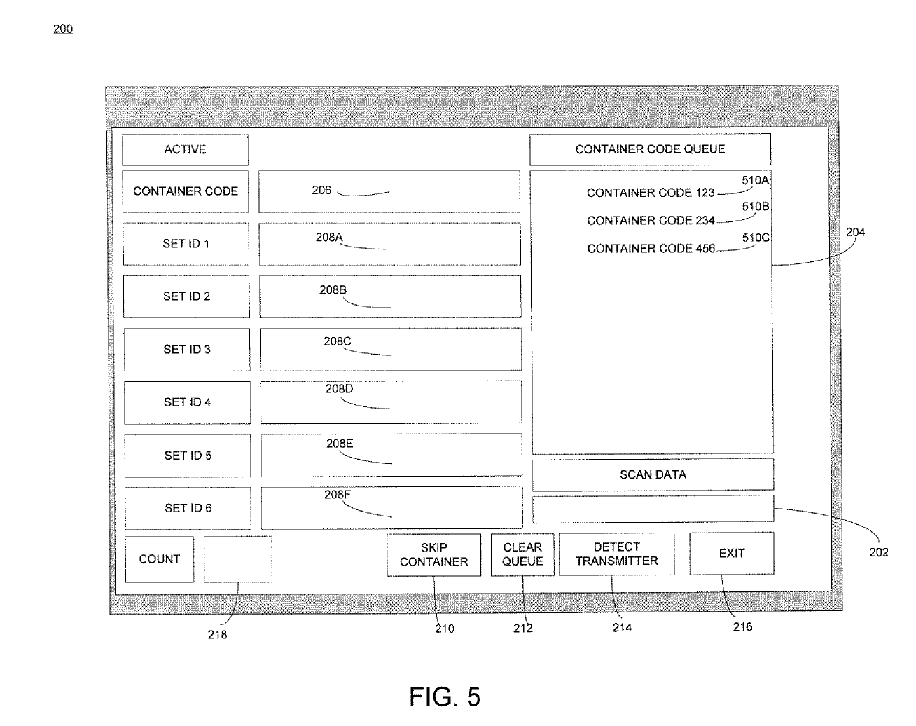

Once the user instructs the Device 102 to activate the wireless reader device, the device software may move the desired container code to the Active Container Code Field 206 in the GUI 200, as depicted in FIG. 6 (e.g., container code ‘123’ is depicted in the Active Container Code Field 206). The device software also may instruct the operator to move the Device 102 near the container 150 to wirelessly read identification information from the one or more transmitter 956 on the one or more tools 854 and/or trays 802 within the container 150. The wireless reader device of the Device 102 may obtain identification information from the one or more tools 854 and/or trays 802 by transmitting a signal to the one or more transmitters 956 within a predetermined distance of the Device 102. The predetermined distance may differ depending on the wireless reader, and may be modified as will be appreciated by those of skill in art. The wireless signal transmitted by the wireless reader device may be, for example, but not limited to, a RF field. The wireless reader device of Device 102 also may be a stationary device, where the container 150 is placed near, under, adjacent, on top of, or relative to the stationary device.

For each of the one or more transmitters 956 within the predetermined distance, the wireless signal of the RF field may energize the one or more transmitters 956 to cause the one or more transmitters 956 to perform a data operation. The data operation may be the retrieval of the identification information stored in the memory of the transmitter 956 and may be followed by the emission of a wireless response signal containing the identification information.

The identification information stored in the memory of the transmitter 956 may also include the container code of the container 150 in which the transmitter 956 is placed. For example, when an individual places the tool 854 in the container 150, the individual may activate a programming device that emits a wireless signal to program the memory of the transmitter 956 to store the container code of the container 150 in which the transmitter 956 is placed. Thus, the device software may compare the container code optically scanned with the container code obtained from the transmitter 956 as a check to make sure the optically scanned container code is associated with the correct transmitter 956.

After the wireless signal of the RF field is emitted by the wireless reader device, the device software may monitor the wireless reader device of the Device 102 to determine if the wireless reader device has received any identification information from the one or more transmitters 956. If the wireless reader device does not receive any identification information within a certain time interval, the device software may instruct the wireless reader device to emit another wireless signal one or more additional times. If the wireless reader device still does not receive a signal from any transmitter 956, the device software may instruct the GUI 200 to display an error message to the operator.

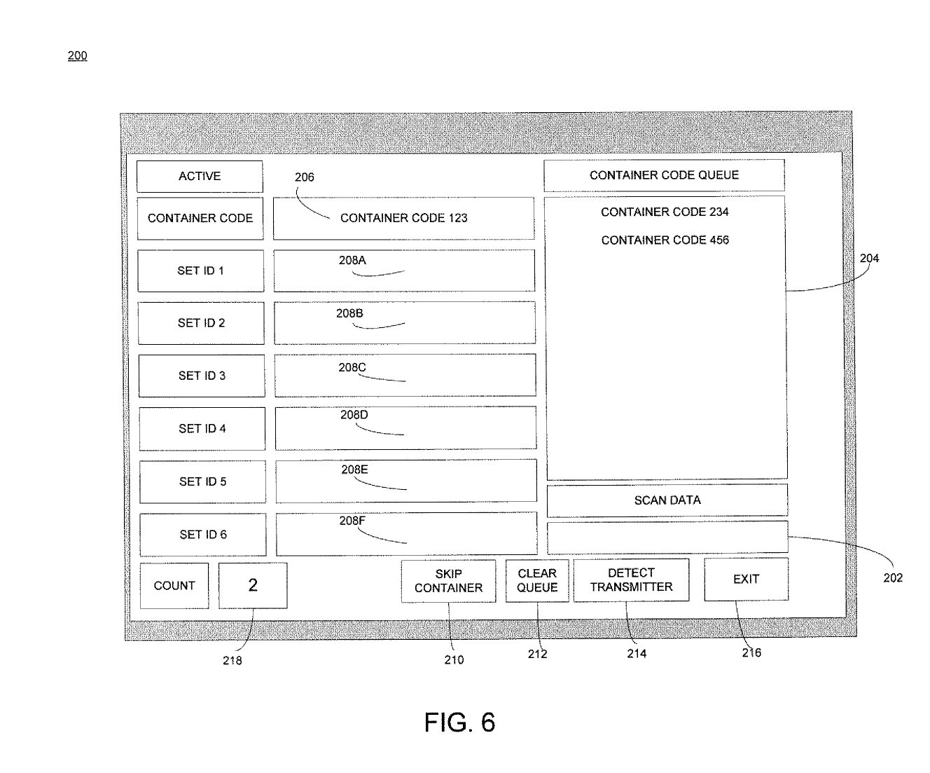

If the wireless reader device receives the wireless response signal from one or more of the transmitters 956, the device software may update the GUI 200 with the identification information of each transmitter 956 from which the wireless reader device has received data. For example, FIG. 7 illustrates the GUI 200 in which the wireless reader device has received identification information from two transmitters 956. As depicted, Active Set Identification Field 208A includes “Transmitter ABC” and Active Set Identification Field 208B includes “Transmitter BCD.” The device software also updates the Count Field 218 to the number “2,” which indicates the number of transmitters 956 detected in the container 150. More or less transmitters 956 may be detected, as will be appreciated by those skilled in the art. The flow diagram 300 may then continue with 316.

In 316, the device software may generate a transaction code based on information received from the optical scanning device and from the wireless reader device. Generally, the transaction code may include the container code and may include the identification information received from the one or more transmitters 956. The flow diagram 300 may then continue with 318.

In 318, the device software may instruct the Device 102 to transmit the transaction code to the Database 110 through the Access Point 104, across the Network 106, and through the Server 108. The device software also may instruct the device to encrypt, scramble, or modify the transaction code prior to transmission for data security. The device software may transmit the transaction code to the Database 110 for updating a database table stored in the Database 110. Processing of the data at the Database 110 is later described below with reference to FIG. 4. The Database 110 then may generate and transmit a response code to the Device 102 based on the transaction code. The flow diagram 300 may then continue with 320.

In 320, the device software may monitor to determine when the Device 102 receives the response code from the Database 108. Once received, the device software may process the response code to instruct the operator on how the container 150 should be processed. For example, the response code may include information such as, but not limited to, shipment information, the expected number of transmitters 956 within the container 150, processing required for the tools 854 and/or trays 802, a processing order for the container 150, the storage location for the container 150, an error code, etc. The flow diagram 300 may then continue with 322.

In 322, based on the response code, the device software may create a response indicator for display by the GUI 200. The response indicator may display, for example, but not limited to, shipment information, special handling instructions, an error code, etc. In an exemplary embodiment, the response indicator may advise the operator of a status of the container 150. The response indicator may change the background color of the GUI 200 to one or more colors, or alternatively, may use some other visual, audible, or vibrational cue.

In various exemplary embodiments, the status of the container 150 may correspond to a color code. For example, to inform the operator how the container 150 may be processed, the device software may illuminate the background of the GUI 200 various colors, such as, but not limited to, red, yellow, and green.

The color red may indicate that the identification information received from the tools 854 is acceptable and that one or more of the tools 854 within the container 150 needs to be processed quickly. In other words, the color red may be a “Hot” indicator indicating that the tools 854 within the container 150 should be processed ahead of other tools and forwarded to its destination as quickly as possible. For example, the tools 854 may need to be sterilized and returned to a hospital to respond to an emergency.

The device software may illuminate the background of the GUI 200 the color yellow to imply an error condition. The error condition may indicate, for example, but not limited to, that the Device 102 did not properly communicate with the one or more of the transmitters 956 within the container 150, that the number of transmitters 956 within the container 150 does not correspond with the expected number of transmitters 956, that two or more different transmitters 956 store identical identification information, that the Database 110 experienced a problem in processing the transaction code, that the identification information includes erroneous or inconsistent information, that the Database timed-out and did not respond, etc. The Device 102 may log any errors using operating system (OS) event logging, or alternatively, may generate a text file. The operator may extract the container 150 for manual inspection and repackaging, based on the indication of an error.

The device software may illuminate the background of the GUI 200 the color green to imply that Device 102 properly received the identification information from the one or more transmitters 956 and that the tools 854 and/or trays 802 may be processed in the order in which they are received.

After the operator has finished processing the container 150, the operator may select to close out the current container 150 and process the next container. In an exemplary embodiment, the operator may select the Container Skip Field 210 (see FIG. 7) to remove the current container code from the Active Container Code Field 206. The device software also may remove the identification information from the Active Set Identification Fields 208A-F and the transmitter count from the Count Field 218. Alternatively, the GUI 200 may omit the Container Skip Field 210 and this function may occur automatically. The flow diagram 300 may then continue with 324.

In 324, the device software may determine if any additional container codes are stored in the queue. If yes, the flow diagram 300 may return to 314 to process the next container code. If no, the flow diagram 300 may continue to 326 and end.

FIG. 4 illustrates a flow diagram 400 of an exemplary embodiment of computer software operating at the Database 110 (the database software) for processing data and communicating with the Device 102. The flow diagram 400 may begin at 402 and may then continue with 404.

In 404, the database software may monitor the Database 110 and the Server 108 for the transaction code transmitted by the Device 102 (also see FIG. 3, 318). Once the database software determines that the Database 110 has received the transaction code, the flow diagram 400 may continue with 406.

In 406, the database software may process the transaction code. The database software may process the transaction code to determine the container code and the identification information from one or more transmitters 956. From the transaction code, the Database 110 may derive the container code of the container 150 and the identification information of the one or more transmitters 956 and place the derived information into a database table stored at the Database 110. For example, the transaction code may be encrypted, scrambled, or otherwise modified by, for example, but not limited to, the Device 102 or the Access Point 104, to protect the transaction code prior to transmission across the Network 106. The Database 110 may derive the container code and the identification information from one or more transmitters 956 by applying appropriate decryption, descrambling, or demodifying to retrieve the transaction code. Once derived, the database software may process the derived information by writing to and reading data from the database table. For example, the database software may write the container code and the identification information to the database table and may read data from the database table.

The database software of the Database 110 may use the database table to evaluate the transaction code received from the Device 102 based on an expected transaction code data previously stored in the database table. For example, the transaction code may identify the shipping and receiving of the transmitters 956 from the processing center to one or more hospitals, assemblers, groups, or manufacturers. If the transmitters 956 are shipped from the processing center to a hospital on a certain date, the expected transaction code data stored in the database table may indicate the shipping date. When the processing center receives the container 150 containing the transmitters 956 back from the hospital the Database 110 may compare the transaction code received from the transmitters 956 with the expected transaction code stored in the database table to generate comparison information. Based on the comparison information, the Database 110 may generate a response code having an error message if the expected transaction code data stored in the database table does not match the identification information received from the transmitters 956.

Additionally, the database table may monitor the history of the tool 854 during its life cycle. The following are exemplary events in the life cycle of the tool 854 that may be monitored and tracked using the database table. Initially, when the container 150 is received, the identification information stored within the memory of the transmitters 956 may be associated with the container code of the container 150. After this stage, the tool 854 may be forwarded to a user, who may sterilize the tool 854 and use a wireless reader device to program a user identification (User ID) number into the memory of the transmitter 956 and the cleaning performed on the tool.

Next, the tool 854 may be forwarded to a hospital for surgery, where a technician may use a wireless reader device to program a surgery number identifying a surgical operation in which the tool 854 was used. After surgery, the technician may again use the wireless reader device to associate the tool 854 with a container 150 which may be sent to the processing center for sterilization. At the processing center, the operator may obtain the identification information, including, but not limited to, the User ID number, the surgery number, the container code, etc., storing the events that tool 854 has underwent. Thus, the database table may monitor the history of events in the life cycle of the tool 854, and may be used to determine when the tool should be refurbished, sterilized, determine who has used the tool, etc. This information may be valuable in instructing what processing the tool 854 should undergo, including safety inspections, sterilization, destination, etc.

The data stored in the database table also may indicate if the one or more tools 854 and/or trays 802 may be processed in the order they were received, ahead of other tools and/or trays previously received. Alternatively, the data stored in the database table may indicate if the database software of the Database 110 could not process the transaction code based on a problem with the transaction code, the identification information from one or more transmitters 956, the container code, or a problem with the Database 110.

Once the transaction code is processed, the Database 110 may generate a response code based on the data stored in the database table. The response code may instruct the device software to generate the response indicator (also see FIG. 3, 322), as discussed above. The flow diagram 400 may then continue with 408.

In 408, the database software of the Database 110 may transmit the response code to the Device 102. The flow diagram 400 may then return to 404.

Thus, the system, apparatus, and computer software according to the exemplary embodiments may quickly and conveniently process a container and tools with minimal manual manipulation of the container by an operator. The in-bound processing system, as discussed herein, utilizing Device 102 may allow for increased efficiency and accuracy in in-bound and out-bound preparation functions for processing tools, such as, but not limited to, surgical instruments and other types of products and tools.

Exemplary embodiments allow a semi-automated system for processing inbound containers utilizing wireless technology. These exemplary embodiments may allow for inventory management of tools and tracking of tool availability, history, and usage. This may allow efficient processing and handling of valuable tools, as well as enhancing the ability to track and maintain records about the tools at a database in a more efficient manner, as compared with current processes.

It is noted that the above descriptions describes scanning the readable code 152 before obtaining the identification information from the transmitters 956. These processes, however, may occur simultaneously, or before or after one another.

Exemplary embodiments describe software that may allow for a scalable and easy to use application for processing in-bound containers and tools without a predefined check point, such as, a conveyor belt or a reader tunnel, where one or more containers 150 would be moved past a reader tunnel at a fixed location. Various exemplary embodiments, however, may be modified to implement a conveyor built system or a reader tunnel, as will be appreciated by those of skill in the art.

In various exemplary embodiments, the software and system may realize efficiencies in autoclave and citric ancillary process through-put by allowing quick identification of containers having tool sets identified as urgent so the tools may be processed through autoclave and ancillary processes earlier than current processes allow. The device may allow for this quick processing of the tools to take place without a check point, such as a conveyor belt for transporting containers, through which all the containers pass in the order in which they are received.

The software described herein is useable with known database and computing systems and may be used to simultaneously or consecutively track information generated from multiple Devices 102. Exemplary embodiments of the software may allow for minimal modification of the system as the software may be scalable with the addition of new features, functionality, and modules, as well as modifications, without having to redesign the entire software application. The software application may be written in commonly used programming environments so that programmers may easily update or add functionality as business requirements dictate.

The software described herein is described as scanning the container as an inbound process where the container is received for various organizations. It is noted, however, that the software and the device also may be used in other stages of container processing. For example, the Device 102 may be used to change a status of the transmitters from inbound receiving, to outbound processing, or may be used to assign the transmitters a particular status. The basic function of reading data from the transmitter with the device and associating the read data to a number gathered from a barcode may be similar in all of these processes. The screens of the GUI and data shown to the user may differ from the GUI 200 to accommodate outbound processing or assigning transmitters a particular status. In will be appreciated, however, that any modifications to the GUI 200 fall within the abilities of one of ordinary skill in the art.

Moreover, it is noted that certain functions are described being performed by certain components within the system 100. It is understood that the functions of various components may be performed by other components within the system 100 that various components may be added or omitted, and/or various combinations thereof.

The exemplary embodiments are not to be limited in scope by the specific exemplary embodiments described herein. For example, although many of the embodiments disclosed herein have been described with reference to surgical instruments, the principles described herein are equally applicable to tracking and monitoring conductive instruments in other environments, such as, but not limited to, automotive, aviation, consumer, and other industries that track the use, maintenance, and location of instruments, tools, and utensils.

Indeed, various modifications of the embodiments, in addition to those described herein, will be apparent to those of ordinary skill in the art from the foregoing description and accompanying drawings. Thus, such modifications are intended to fall within the scope of the embodiments. Further, although some of the embodiments have been described herein in the context of a particular implementation in a particular environment for a particular purpose, those of ordinary skill in the art will recognize that its usefulness is not limited thereto and that the embodiments can be beneficially implemented in any number of environments for any number of purposes.

1. A software method comprising:
receiving scan data from a device after the device retrieves a readable code from a container, the container having at least one transmitter contained therein;
processing the scan data to generate a container code based on the readable code;
receiving a signal from the at least one transmitter, the signal including identification information;
generating a transaction code based on the container code and the identification information; and
instructing the device to transmit the transaction code to a processing device.

2. The software method of claim 1, wherein processing the scan data further comprises:
instructing the device to display in a user interface whether the device successfully retrieved the readable code.

3. The software method of claim 2, wherein the user interface displays a message indicating that the device did not successfully retrieve the readable code.

4. The software method of claim 1, wherein processing the scan data further comprises:
queuing the container code in a queue.

5. The method of claim 1, further comprising:
receiving a response code from the processing device

6. The method of claim 5, further comprising:
generating a response indicator based on the response code.

7. The method of claim 6, wherein the response indicator includes one or more selecting from the group consisting of: an audible cue, a visual cue, a vibrational cue, color coded data, a processing order, an error message, destination information, and combinations thereof.

8. The method of claim 1, wherein the identification information includes one or more selecting from the group consisting of: a Universal Product Code, a product name, a unique identification number, a processing order, a shipping date, a received date, a number of usages, a manufacturer, a number of uses, a number of sterilizations, a last sterilization date, a last usage date, a point of origin, a destination, a number of refurbishments, an age, previous user information, usage date information, and combinations thereof.

9. A software method for a processing device comprising:
receiving a transaction code transmitted from a device, the transaction code including data corresponding to a container code of a container and identification information of a transmitter associated with the container;
updating a database table based on the container code and the identification information;
generating a response code based on information stored in the database table, the response code being usable by the device to generate a response indicator for processing the container; and
transmitting the response code to the device.

10. The software method according to claim 9, wherein the response code includes one or more selected from the group consisting of: shipment information, an expected number of transmitters, required processing information, a processing order, storage information, an error code, and combinations thereof.

11. The software method according to claim 9, wherein the database table stores a previous transaction code received from the device.

12. The software method according to claim 10, further comprising:
comparing the previous transaction code with the transaction code to generate comparison information.

13. The software method according to claim 12, further comprising:
generating the response code based on the comparison information.

14. A system comprising:
an access point,
a container, the container comprising a readable code and having at least one transmitter contained therein;
a device, the device being adapted to retrieve the readable code and being adapted to generate a wireless signal and to receive a response signal transmitted from the transmitter in response to the wireless signal, the device being adapted to generate a transaction code based on the readable code and the response signal, and to transmit the transaction code to the access point.

15. The system according to claim 14, further comprising:
a database, wherein the access point is adapted to transmit the transaction code to the database and the database is adapted to process the transaction code and to generate a response code based on the transaction code.

16. The system according to claim 15, wherein device comprises a wireless communication device and a scanning device.

17. The system according to claim 14, wherein the device is a handheld device.

18. The system according to claim 14, wherein the device includes a display.

19. The system of claim 14, wherein the device wirelessly exchanges data with the access point.

20. The system of claim 14, further comprising:
a server, wherein the server receives the transaction code from the access point across a network.

21. One or more computer-readable media having computer-readable instructions thereon which, when executed by a computer, cause the computer to:
receive scan data from a device after the device retrieves a readable code from a container, the container having at least one transmitter contained therein;
process the scan data to generate a container code based on the readable code;
receive a signal from the at least one transmitter, the signal including identification information;
generate a transaction code based on the container code and the identification information; and
instruct the device to transmit the transaction code to a processing device.

22. One or more computer-readable media having computer-readable instructions thereon which, when executed by a computer, cause the computer to:
receive a transaction code transmitted from a device, the transaction code including data corresponding to a container code of a container and identification information of a transmitter associated with the container;
update a database table based on the container code and the identification information;
generate a response code based on information stored in the database table, the response code being usable by the device to generate a response indicator for processing the container; and
transmit the response code to the device.
